(19) United States
(12) Patent Application Publication
(10) Pub. No.: US 2022/0221394 A1
(43) Pub. Date: Jul. 14, 2022

(54) METHOD AND SYSTEM FOR TESTING AN ADHESIVE USED FOR A FEMININE CARE PAD

(71) Applicant: Bostik Inc., Wauwatosa, WI (US)

(72) Inventors: Luke A. BURKHOLDER, Wauwatosa, WI (US); Russell P. STUCZYNSKI, Wauwatosa, WI (US); Kayla VAN DYKE, Wauwatosa, WI (US); Gautier HOURIEZ, Wauwatosa, WI (US)

(21) Appl. No.: 17/610,489

(22) PCT Filed: May 13, 2020
(86) PCT No.: PCT/US2020/032643

§ 371 Date: Nov. 11, 2021

Related U.S. Application Data
(60) Provisional application No. 62/847,486, filed on May 14, 2019.

(51) Int. Cl. G01N 19/04

(52) U.S. Cl. CPC G01N 19/04; G01N 2203/0091

(57) ABSTRACT

A system for testing an adhesive used for an adhesive-backed hygiene article, such as a feminine care pad, a breast pad, or certain adult incontinence pads, comprises first and second substrates defining a gap for positioning a weight which, by using a force measurement system, is caused to move over the substrate and to detach the adhesive-backed hygiene article from the cloth material. A method utilizes the system and measures the force as the weight moves after the weight contacts the adhesive-backed hygiene article. The force measured is reflective of the entire system, both the force required to cause the adhesive between the article and the cloth material to fail and for the article to bunch on itself. Depending on the specific test, one or two weights may be used.

### FIELD OF THE INVENTION

This invention relates to methods and systems for testing the adhesive properties of an adhesive used to mount an adhesive-backed hygiene article, such as a feminine care pad, on a cloth material.

### BACKGROUND OF THE INVENTION

Certain hygiene articles have adhesive on their outer surface, which is intended to face a garment and thereby adhere the article to a garment, such as underwear, bra, or a bathing suit. The inner surface (or body-facing surface) of such hygiene articles are intended to absorb body fluids. Such hygiene articles include feminine care pads, breast pads, and certain adult incontinence pads.

As can be appreciated, it is important the adhesive adheres well to the garment in a variety of conditions, such as after exposure to increased temperature, after being insulted with fluid, and despite having force acted on it in a number of directions. Moreover, the adhesive must adhere well to a variety of cloth materials used in undergarments and bathing suits currently and in the future.

It has been found difficult to simulate the particular conditions for such articles, especially feminine care pads, in order to predict the usefulness of any particular adhesive, coating weight of an adhesive, and adhesive pattern used on the article. Such testing has included peel testing by mating an article to a cloth material and conducting peel testing by pulling them apart, in an unsupported manner. Other testing has included testing of insulted pads for leaks when a non-linear or dynamic movement is applied, for example by twisting and without being adhered to fabric.

Standards exist for the testing of hygiene articles, e.g. those collected by the EDANA Nonwovens Industry Group. The majority of these tests focus on the properties of the nonwoven, filmic, and adsorbent materials used to make hygiene products (i.e. the tear strength of a nonwoven material, the burst strength of a filmic material, or the absorbency of superabsorbent polymers) on the absorbency and leakage of assembled absorbent hygiene articles, and on the general guidelines of proper experimental design, data collection, and data analysis (e.g. for Composite Lamination Strength i.e. peel testing). There is no generally accepted standard method to test for the properties of an absorbent hygiene article that make it stay in place during use.

### SUMMARY OF THE INVENTION

It would be desirable to develop a method and system which more accurately predicts the usefulness of an adhesive, a particular coating weight, and an adhesive pattern on an adhesive-backed hygiene article. Not only would it be desirable to identify the existence of any movement of an article relative to a cloth material, but determining the force required to cause such movement along with the mechanism of failure would also be helpful.

In view of the shortcomings of the prior art, an embodiment of the invention comprises a method for testing an adhesive used for an adhesive-backed hygiene article, said method comprising the steps of: adhering a cloth material to a first substrate to immobilize the cloth material on a top surface of the first substrate; placing at least one weight on the top surface, wherein a lead line is attached to the at least one weight; adhering an adhesive-backed hygiene article to the cloth material; mounting a second substrate to the first substrate; and exerting force on the at least one weight to move the at least one weight over the cloth material and to detach the adhesive-backed hygiene article from the cloth material, while measuring the force as the at least one weight moves after the at least one weight contacts the adhesive-backed hygiene article.

According to another embodiment of the invention, a system for testing an adhesive used for an adhesive-backed hygiene article comprises: a first substrate having a top surface adapted to accommodate a cloth material and an adhesive-backed hygiene article adhered to the cloth material; a second substrate mounted to the first substrate defining a gap between the first substrate and the second substrate; at least one weight disposed on the top surface and positioned within the gap; a force measurement system for exerting force on the at least one weight to move the at least one weight over the cloth material and to detach the adhesive-backed hygiene article from the cloth material, while measuring the force as the at least one weight moves after the at least one weight contacts the adhesive-backed hygiene article.

According to another embodiment of the invention, an adhesive formulation may be identified by the method and system of the present invention as the formulation having the most optimal adhesive properties relative to a plurality of adhesive formulations tested according to the method and system of the invention, such as over 10, 50, or 100 possible adhesive formulations. In one embodiment, such adhesive formulation demonstrates the most optimal adhesive properties used to mount a feminine care pad to a cloth material. The invention contemplates such adhesive formulation and a feminine care pad made with such adhesive formulation.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. Included in the drawing are the following figures:

FIG. 1 is a perspective view of an assembled system for testing an adhesive used for an adhesive-backed hygiene article according to an embodiment of the invention;

FIG. 2 is a plan view of the components of the system shown in FIG. 1;

FIG. 3A is a top view of certain components, including the first substrate, of the system shown in FIG. 1;

FIG. 3B is a top view of the second substrate of the system shown in FIG. 1;

FIG. 4 is a top view of the first substrate of the system shown in FIG. 1 with an adhesive-backed hygiene article having wings mounted thereon;

FIG. 5A shows the preferred cut lines in a cloth material according to an embodiment of the present invention;

FIG. 5B shows the preferred fold lines in a cloth material according to an embodiment of the present invention;

FIG. 6 is a top view of the first substrate of the system shown in FIG. 1 with an adhesive-backed hygiene article having wings mounted thereon, with the wings attached to the bottom surface of the first substrate adjacent to recesses of the first substrate;

FIG. 7A is a top view of certain components, including the first substrate, of another embodiment of the present invention;

FIG. 7B is a top view of the second substrate of the system shown in FIG. 7A;

FIG. 8 is a graph showing load versus distance achieved by testing a feminine care pad according to the Example herein.

### DETAILED DESCRIPTION OF THE INVENTION

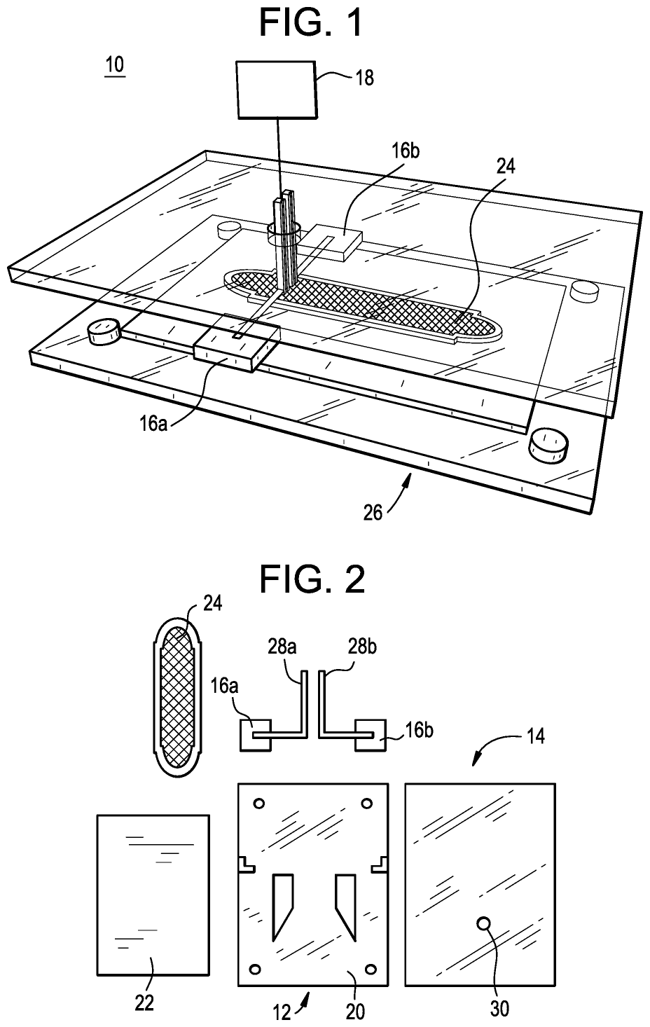

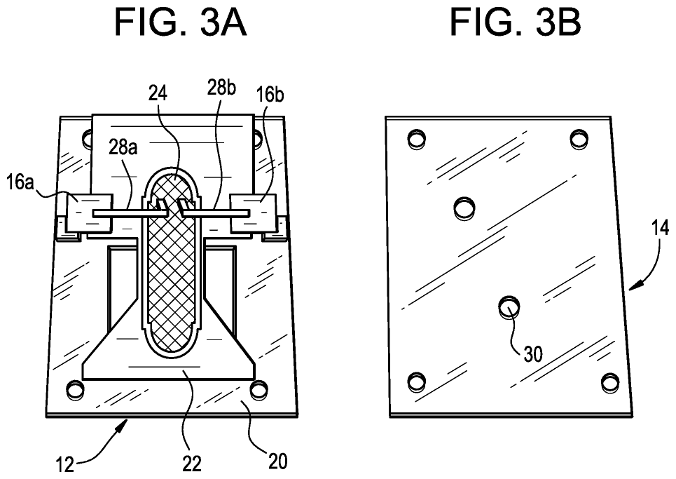

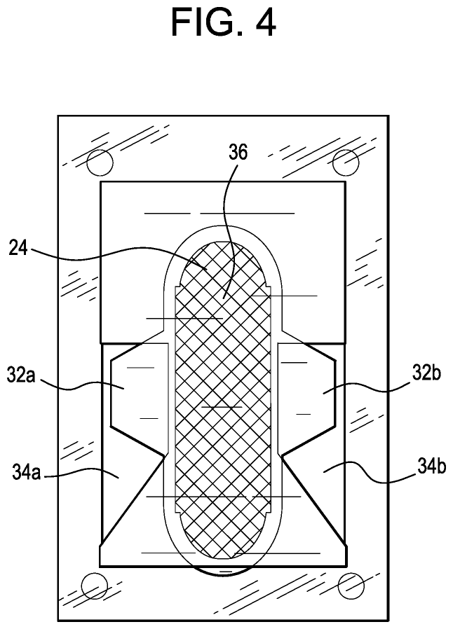

An embodiment of the present invention is directed to a system for testing an adhesive used for an adhesive-backed hygiene article, such as a feminine care pad, a breast pad, or certain adult incontinence pads adapted to be adhered to an undergarment. As shown in FIGS. 1, 2, 3A, and 3B, system 10 comprises a first substrate 12; a second substrate 14 mounted to the first substrate; at least one weight 16a, 16b; and a force measurement system 18. First substrate 12 has a top surface 20 adapted to accommodate a cloth material 22 and an adhesive-backed hygiene article 24 adhered to the cloth material. Second substrate 14 is mounted to first substrate in a way (e.g., through nuts and bolts) to define a gap 26 between the first substrate and the second substrate, namely between the top surface 20 of the first substrate and the bottom surface of the second surface. A wide range of materials may be used for first substrate 12 and second substrate 14, and plexiglass has been found to be suitable. At least one weight 16a, 16b is disposed on top surface 20 of first substrate 12 and positioned within gap 26. Although the term “weight” is used, it is not critical that a true “weight” is used; any block or other shape of a solid may be used, and the force measurement system can be programmed appropriately and in a known way. Force measurement system serves to exert tension on at least one weight 16a, 16b to draw the at least one weight over cloth material 22 and to detach the adhesive-backed hygiene article 24 from the cloth material, while measuring the force as the at least one weight moves after the at least one weight contacts the adhesive-backed hygiene article. It may be possible to configure the system in another way, for example, by exerting a pushing force from the outer sides of the at least one weight towards one another and to move the at least one weight over cloth material 22 and to detach the adhesive-backed hygiene article 24 from the cloth material, while measuring the force.

Although the embodiments shown display a feminine care pad as the hygiene article, the system and method of the present invention may be used with any other adhesive-backed hygiene article, such as a breast pad and an adult incontinence pad. In addition, the system and method of the present invention may be used with feminine care pads with or without wings. Furthermore, the system and method of the present invention may be used with a wide range of cloth materials, namely any cloth material which is suitable for clothing, especially undergarments. Thus, the cloth material may include the following: cotton, polyester, silk, nylon, spandex, elastane, reconstituted cellulose, wool, or blends thereof.

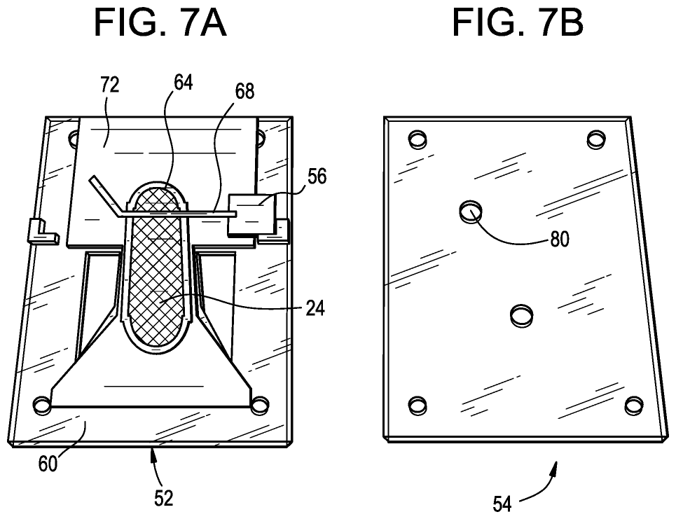

In the embodiment shown in FIGS. 1, 2, 3A, and 3B, each of the weights 16a, 16b has a respective lead line 28a, 28b attached thereto and extending therefrom. Once assembled, lead lines 28a, 28b extend through and are accommodated by an opening 30 in second substrate 14 and are attached to force measurement system 18 via such opening. It is possible to configure the system in another way, such as to feed the lead lines to force measurement system 18 by another route, such as through an opening in first substrate 12. Although not shown, it is preferable to couple the lead lines in a way that force measurement system 18 causes the two weights 16a, 16b to begin moving at the same time and to move over an equal distance. The embodiment shown in FIGS. 1, 2, 3A, and 3B uses two weights 16a, 16b (called the bunch test herein), and the embodiment shown in FIGS. 7A and 7B below uses a single weight (called the side test herein).

It is desirable to mount cloth material 22 in a way such that it is smoothly and substantially immobilized on first substrate 12. The reason for this is to ensure that the force, when measured, is reflective of article 24 becoming dislodged from cloth material 22 but not the cloth material becoming separated from first substrate 12. If so, this could adversely impact the accuracy of the data, as it would not be reflective of just article 24 becoming dislodged from cloth material 22.

This substantial immobilization may be achieved through a hook and loop attachment of cloth material 22 to first substrate 12 in the embodiment shown in FIGS. 1, 2, 3A, and 3B. In particular, system 10 further comprises hook tape (not shown) adhered to top surface 20 of first substrate 12 and the bottom surface of the first substrate at locations where the cloth material is folded over. Hook tape can be adhered to the entireties of both surfaces of first substrate 12 or just portions thereof or, more preferably, at only those surfaces where it is intended that the cloth material will be disposed in operation of the system. The cloth material serves as the loop material and therefore is substantially immobilized by a hook-and-loop mechanism.

The system of the present invention includes a force measurement system 18 for exerting force on the at least one weight to move the at least one weight over the cloth material and to detach the adhesive-backed hygiene article from the cloth material, while measuring the force as the at least one weight moves after the at least one weight contacts the adhesive-backed hygiene article. The force measurement system may be any known force measurement system used to measure load of moving a weight over a surface. Such force measurement systems are available from Instron of Norwood, Mass. One system deemed suitable is the Intron 5500R system. It is coupled to the lead lines at one end and to the mounted and assembled substrates at the other end, for example to a protrusion extending from the bottom surface of first substrate 12 in a direction away from second substrate 14. The force measurement system can be used in a known way, including using the software associated with the system.

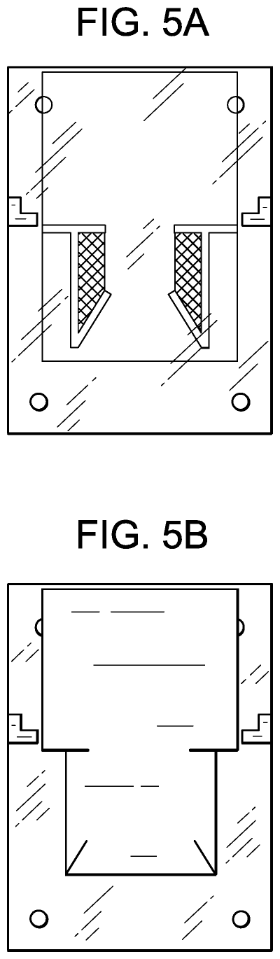

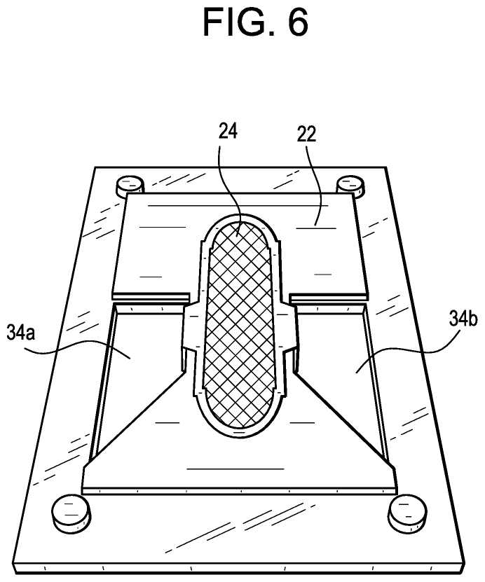

In the embodiment shown in FIGS. 5, 5A, 5B and 6, system 10 is configured to accommodate an adhesive-backed hygiene article 24 having wings 32a, 32b. Such wings are known to better affix an adhesive-backed hygiene article to an undergarment by allowing for the wings to be folded over an edge of the undergarment and adhered to the outer surface thereof (i.e., the surface of the undergarment facing away from the body). In order to simulate this aspect, recesses 34a, 34b are formed in the first substrate 12 and serve to accommodate wings 32a, 32b of adhesive-backed hygiene article 24. In addition, recesses 34a, 34b accommodate cloth material 22 and allow it to be folded over to the bottom surface of first substrate 12 adjacent to the recesses. Thus, just as when an adhesive-backed hygiene article with wings is used by a wearer, the wings are folded around an edge and adhered to cloth material on the other side thereof. This is intended to best simulate a pad as worn by a user.

To improve repeatability, it is preferable to ensure that the weight does not either turn or twist within the plane defined by gap 26 formed by first substrate 12 and second substrate 14 (i.e., the x-y plane). This is preferable to ensure repeatability of the test. Including recesses 34a, 34b to accommodate wings 32a, 32b is one way to avoid this. Another way is to provide each weight 16a, 16b with a linear protrusion extending upward from the weights towards second substrate 14 in operation and extending parallel to the direction of travel. This protrusion would mate with a linear groove formed in the bottom surface of second substrate 14 as the at least one weight moves. This serves to stabilize the weights regardless of whether the article has wings. Moreover, it is preferable that the height of gap 26 is close to the height of the weights so that the weights cannot move in the z-direction, which could impact the test results. In other words, it would be undesirable to permit the weights to be risen up and ride over the top of the article. Preferably, the materials of the substrates and weights are selected such that little frictional resistance occurs.

Another feature of embodiments of the invention is the use of an indicator point 36, which a user marks on the inner side of the adhesive-backed hygiene article at a point corresponding to the central point of contact of the at least one weight with the article. As shown, the dot is placed at the back of the article. It has been found that exposing the back of the pad to some force reflects more accurately the typical force exerted upon feminine care pads. Before fully adhering an article to the cloth material, the second substrate is placed over the first substrate and the pad can be checked (and moved, as needed) to ensure that the indicator point is aligned with the opening of the second substrate.

According to another embodiment of the invention, a method for testing an adhesive used for an adhesive-backed hygiene article comprises the steps of: adhering a cloth material 22 to a first substrate 12 to immobilize the cloth material on a top surface 20 of the first substrate; placing at least one weight 16a, 16b on the top surface; adhering an adhesive-backed hygiene article 24 to the cloth material; mounting a second substrate 14 to the first substrate; and exerting force on the at least one weight to move the at least one weight over the cloth material and to detach the adhesive-backed hygiene article from the cloth material, while measuring the force as the at least one weight moves after the at least one weight contacts the adhesive-backed hygiene article. In this way, the force measured is reflective of the entire system, both the force required to cause the adhesive between the article and the cloth material to fail and for the article to bunch on itself.

In the embodiment shown in FIGS. 1, 2, 3A, and 3B, lead lines 28a, 28b are attached the respective weights 16a, 16b, and second substrate 14 has an opening 30 to accommodate the lead lines. In this embodiment, the method further comprises extending lead lines 16a, 16b through opening 30. As mentioned above, it is preferable to couple the lead lines in a way that force measurement system 18 causes the two weights 16a, 16b to begin moving at the same time and to move over an equal distance. As discussed below, it is preferable to remove any slack from the lines before beginning the measurement of force to exert tension on the lines, to improve repeatability and to avoid taking measurements of merely tightening the lines (as opposed to moving the weights). The method could involve using two weights or one weight.

As discussed previously, the embodiment shown in FIGS. 5, 5A, 5B and 6, system 10 is configured to accommodate an adhesive-backed hygiene article 24 having wings 32a, 32b. The method for using such a system may include cutting the cloth material to reduce the formation of pleats upon adhering cloth material to a substrate having recesses to accommodate wings of a hygiene article. Preferred cut lines of the cloth material are shown in FIG. 5A. The preferred fold lines are shown in FIG. 5B. These cuts and folds serve to wrap the cloth around the first substrate with an absence of wrinkles or pleats.

As can be appreciated, cloth material 20 can become impacted after several test cycles by retaining residual adhesive and thereby influencing its frictional resistance and thereby impacting the results. Therefore, it is preferable to replace the cloth material periodically. Preferably, the cloth material is replaced after 3-20 test cycles, preferably after 3-10 test cycles, and most preferably after 3-7 test cycles.

As stated above, the method may be used with the at least one weight having a linear protrusion and the second substrate having a corresponding linear groove on its bottom surface adapted to mate with the protrusion as the at least one weight moves. In addition, the method may comprise marking an indicator point on the inner side of the adhesive-backed hygiene article at a point corresponding to the desired central point of contact of the at least one weight with the article.

According to an embodiment of the invention, the method further comprises, prior to the exerting force step, at least one of the following: insulting the article with fluid, exposing the article to an increased temperature for a specified duration, or applying weight to the article. This is intended to simulate real-life scenarios imposing additional challenges to the adhesive. For example, the hygienic article could get wet in use, could be exposed to increased temperature, or could be subjected to additional forces. Therefore, these modifications to the method of the invention would serve to better simulate these potential real-life scenarios.

The force measurement system could be selected to provide a wide range of useful data. Most importantly is the force (or load) required to move the weight as the article is becoming detached from the cloth material. Other values might include the average load over a given distance, such as the range of distances where the article was affixed to the cloth material, as well as the instantaneous load value or its slope, especially at the point where the weight first contacts the article. The method may further comprise obtaining, from the force measured, an average force during the distance traveled corresponding to when the at least one weight is in contact with the adhesive-backed hygiene article. In an embodiment, the value of the slope of the force-distance curve is noted at the point where the article just begins to move. A high force value and/or high slope at this point reflects a preferred adhesive, adhesive loading, and/or adhesive pattern.

FIGS. 7A and 7B show an alternative embodiment of the system of the present invention in which only one weight is used. This embodiment is used to simulate how an adhesive, its coating weight, and/or its pattern of application responds to a different force profile exerted upon the article. In particular, the embodiment of FIGS. 7A and 7B simulates a situation where force is imparted to the article from only one direction; thus the bunching of the article occurs across the entire width of the article. On the other hand, the embodiment of FIGS. 1, 2, 3A, and 3B simulates a situation where force is imparted to the article from both directions in an equal manner; thus the bunching of the article occurs from the edges to the center of the article.

The embodiment shown in FIGS. 7A and 7B is generally similar to the embodiment shown in FIGS. 1, 2, 3A, and 3B. As shown in FIG. 7A, first substrate 52 has a top surface 60 for accommodating a cloth material 72, on which may be adhered an adhesive-backed hygiene article 64. Weight 56 is disposed on top surface 60 of first substrate 52 and positioned within a gap between the first substrate and second substrate 52 after the second substrate is mounted to the first substrate. Lead line 68 extends across the entire width of the article and is fed through opening 80 formed in second substrate 54 shown in FIG. 7B, where it extends to and is attached to a force measurement system. As can be seen in FIG. 7B, opening is offset from the center of the width of second substrate 54 to correspond to the location of where lead line 68 should extend upwardly from the gap between the substrates, namely at the edge of the article opposite from the weight.

In carrying out the method, the following approach may be used. First, a cloth material is mounted to the first substrate by adhering the cloth (serving as the loop) to hook tape attached to the first substrate. Then, an adhesive-backed hygiene article is attached to the cloth material at the desired location, lining up the article so that a desired surface will be contacted by the at least one weight. To improve repeatability, the same force should be imparted to the article when adhering it to the cloth material. For example, the same number of passes (e.g., 2) of a standard 2 kg roller may be used with no additional downward pressure exerted on the roller. After the weights are positioned on the first substrate, the lead lines are fed through the opening on the second substrate and the substrates are bolted together. Then the software associated with the force measurement system is opened and the type of test is specified (i.e., bunch or side). The assembled system is then attached to the force measurement system, by clipping the board into lower jaw of the force measurement system and clipping the lead line(s) extending from the weight(s) to the top jaw of the force measurement system. Next, the jaws are adjusted to remove most of the slack from the string and the load cell is zeroed out. The test is then run by starting the force measurement system. The software of the system controls the following: the rate at which the lead lines are moved is set to a particular value; the minimum force is identified at which it begins to record data; the distance over which the weights are moved is specified (e.g., between 4 and 8 cm for the bunch test and between 7 and 11 cm for the side test); and the data is recorded and the system returns the weights to their original position after the test. Next, the user identifies the locations on the data corresponding to the points at which the weight was contacting the article. The software calculates the average load and average slope values over this range. The user also records comments on the failure mode. After some number of tests (e.g., 5 tests), a fresh sample of cloth material replaces the existing cloth material.

According to another embodiment of the invention, a plurality of adhesive formulations are tested according to a method or system of the present invention. Each adhesive formulation would be found to have its own adhesive properties based on the method or system of the invention. The adhesive formulation having the most optimal adhesive formulation would be identified. The number of formulations tested could be any number greater than two, such as 10, 50, or 100, or any number greater than those. In one embodiment, such adhesive formulation demonstrates the most optimal adhesive properties used to mount a feminine care pad to a cloth material. The invention contemplates such adhesive formulation and a feminine care pad made with such adhesive formulation.

### Aspects of the Invention

Aspect 1. A method for testing an adhesive used for an adhesive-backed hygiene article, said method comprising the steps of:

adhering a cloth material to a first substrate to immobilize the cloth material on a top surface of the first substrate;

placing at least one weight on the top surface, wherein a lead line is attached to the at least one weight;

adhering an adhesive-backed hygiene article to the cloth material;

mounting a second substrate to the first substrate; and

exerting force on the at least one weight to move the at least one weight over the cloth material and to detach the adhesive-backed hygiene article from the cloth material, while measuring the force as the at least one weight moves after the at least one weight contacts the adhesive-backed hygiene article.

Aspect 2. The method of aspect 1, wherein at least one lead line is attached to the at least one weight and the second substrate has an opening to accommodate the at least one lead line, and the method further comprises extending the at least one lead line through the opening.

Aspect 3. The method of aspects 1 or 2, wherein the at least one weight consists of one weight.

Aspect 4. The method of aspects 1 or 2, wherein the at least one weight consists of two weights.

Aspect 5. The method of any of aspects 1 to 4, wherein the cloth material is folded over edges of the first substrate and the cloth material is adhered to the bottom surface of the first substrate.

Aspect 6. The method of any of aspects 1 to 5, wherein hook tape is adhered to the top surface of the first substrate and the bottom surface of the first substrate at locations where the cloth material is folded over.

Aspect 7. The method of any of aspects 1 to 6, wherein the adhesive-backed hygiene article has wings and the first substrate has recesses to accommodate the wings of the adhesive-backed hygiene article and the cloth material to be folded over to the bottom surface of the first substrate adjacent to the recesses.

Aspect 8. The method of aspect 7 further comprising cutting the cloth material to reduce formation of pleats upon adhering the cloth material to the first substrate.

Aspect 9. The method of aspect 7 further comprising cutting the wings or repositioning the article axially.

Aspect 10. The method of any of aspects 1 to 9 further comprising replacing cloth material after a 3-20 test cycles, preferably from 3-10 test cycles, and most preferably from 3-7 test cycles.

Aspect 11. The method of any of aspects 1 to 10, wherein the measuring step comprises measuring the force and the slope of the force based on the linear distance traveled by the at least one weight load.

Aspect 12. The method of any of aspects 1 to 11 further comprising obtaining, from the force measured, an average force during the distance traveled corresponding to when the at least one weight is in contact with the adhesive-backed hygiene article.

Aspect 13. The method of any of aspects 1 to 12, wherein the adhesive-backed hygiene article is selected from the group consisting of a feminine care pad with or without wings, a breast pad, and an adult incontinence pad.

Aspect 14. The method of any of aspects 1 to 13, wherein the at least one weight has a linear protrusion and the second substrate has a linear groove on its bottom surface adapted to mate with the protrusion as the at least one weight moves.

Aspect 15. The method of any of aspects 1 to 14 further comprising marking an indicator point on the inner side of the adhesive-backed hygiene article at a point corresponding to the central point of contact of the at least one weight with the article.

Aspect 16. The method of any of aspects 1 to 15, wherein the cloth material is selected from the group consisting of cotton, polyester, silk, nylon, spandex, elastane, reconstituted cellulose, wool, or blends thereof.

Aspect 17. The method of any of aspects 1 to 16 further comprising, prior to the exerting force step, at least one of the following: insulting the article with fluid, exposing the article to an increased temperature for a specified duration, or applying weight to the article.

Aspect 18. A system for testing an adhesive used for an adhesive-backed hygiene article, said system comprising:

a first substrate having a top surface adapted to accommodate a cloth material and an adhesive-backed hygiene article adhered to the cloth material;

a second substrate mounted to the first substrate defining a gap between the first substrate and the second substrate;

at least one weight disposed on the top surface and positioned within the gap;

a force measurement system for exerting force on the at least one weight to move the at least one weight over the cloth material and to detach the adhesive-backed hygiene article from the cloth material, while measuring the force as the at least one weight moves after the at least one weight contacts the adhesive-backed hygiene article.

Aspect 19. The system of aspect 18 further comprising a lead line attached to the at least one weight, wherein the second substrate has an opening to accommodate the lead line, wherein the lead line is attached to the force measurement system.

Aspect 20. The system of any of aspects 18 or 19, wherein the at least one weight consists of one weight.

Aspect 21. The system of any of aspects 18 or 19, wherein the at least one weight consists of two weights.

Aspect 22. The system of any of aspects 18 to 21 further comprising hook tape adhered to the top surface of the first substrate and the bottom surface of the first substrate at locations where the cloth material is folded over.

Aspect 23. The system of any of aspects 18 to 22, wherein the first substrate has recesses to accommodate the wings of the adhesive-backed hygiene article and the cloth material to be folded over to the bottom surface of the first substrate adjacent to the recesses.

Aspect 24. The system of any of aspects 18 to 23, wherein the at least one weight has a linear protrusion and the second substrate has a linear groove on its bottom surface adapted to mate with the protrusion as the at least one weight moves.

Aspect 25. The system of any of aspects 18 to 24, wherein the force measurement system comprises means for determining the average force as the at least one weight moves after the at least one weight contacts the adhesive-backed hygiene article and the slope of a force-distance curve as the at least one weight moves after the at least one weight contacts the adhesive-backed hygiene article.

Aspect 26. An adhesive formulation having the most optimal adhesive properties relative to a plurality of adhesive formulations tested according to the method of aspects 1-17 or the system of aspects 18-25.

Aspect 27. A feminine care pad made with the adhesive formulation of aspect 26.

### Example

The following provides an example of the use of method and system of the present invention.

As system as shown in FIGS. 1, 2, 3A, and 3B was used to test the adhesive of a feminine care pad. The system used plexiglass substrates and 250 g brass weights. An Instron 5500R (including Bluehill Software) available from Illinois Tool Works was used as the force measurement system. Two weights were used, so a bunch test was carried out on a commercially available feminine care pad.

In carrying out the method, a cotton cloth material was mounted to the first substrate by adhering the cloth (serving as the loop) to hook tape attached to the first substrate. Then, the adhesive-backed hygiene article was attached to the cloth material at the desired location, namely so that the weights could contact the article along the entire facing side of the weight near the back of the article. To adhere the article to the cloth material, two passes of a standard 2 kg roller were made with no additional downward pressure exerted on the roller. After the weights were positioned on the first substrate, the lead lines were fed through the opening on the second substrate and the substrates were bolted together. Then, the software associated with the force measurement system was opened and the type of test was specified (i.e., bunch). The assembled system was then attached to the force measurement system, by clipping the board into lower jaw of the force measurement system and clipping the lead line(s) extending from the weight(s) to the top jaw of the force measurement system. Next, the jaws were adjusted to remove most of the slack from the string and the load cell was zeroed out. The test was then run by starting the force measurement system.

The software of the system was set as follows:
a. Initial rate of movement was set to 16.5 cm/min;
b. The force to start to record data was set to 50 gf (grams of force) is felt at default data capture rate;
c. The distance to move the weights was set at 6.5 cm for the bunch test; and
d. The data was recorded data and the weights were returned to their initial position at the completion of the test run.

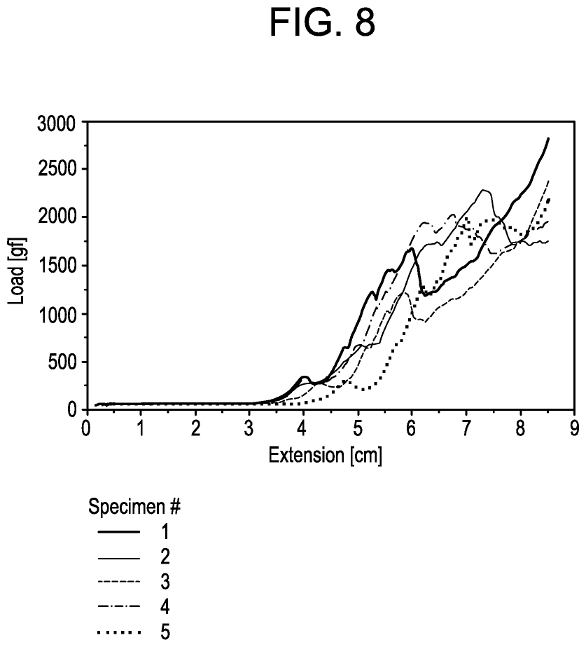

After the test, the user identified the locations on the data corresponding to the points at which the weight was contacting the article, namely at 3 cm to 6 cm. The software then calculated the average load and the average slope based on those inputs. Attached as FIG. 8 is the data from five such runs. As can be seen, the first 3.5 cm reflect moving the weights along the cloth material before the weights contact the article. Once the article is contacted the load appropriately increases. By inspection, a user can notate where the article first visibly moved. By comparing sets of data with different conditions, namely different articles, different adhesives, different adhesive loadings, and different adhesive patterns, one can identify an optimal system.

1. A method for testing an adhesive used for an adhesive-backed hygiene article, said method comprising the steps of:
adhering a cloth material to a first substrate to immobilize the cloth material on a top surface of the first substrate;
placing at least one weight on the top surface, wherein a lead line is attached to the at least one weight;
adhering an adhesive-backed hygiene article to the cloth material;
mounting a second substrate to the first substrate; and
exerting force on the at least one weight to move the at least one weight over the cloth material and to detach the adhesive-backed hygiene article from the cloth material, while measuring the force as the at least one weight moves after the at least one weight contacts the adhesive-backed hygiene article.

2. The method of claim 1, wherein at least one lead line is attached to the at least one weight and the second substrate has an opening to accommodate the at least one lead line, and the method further comprises extending the at least one lead line through the opening.

3. The method of claim 1, wherein the at least one weight consists of one weight.

4. The method of claim 1, wherein the at least one weight consists of two weights.

5. The method of claim 1, wherein the cloth material is folded over edges of the first substrate and the cloth material is adhered to the bottom surface of the first substrate.

6. The method of claim 1, wherein hook tape is adhered to the top surface of the first substrate and the bottom surface of the first substrate at locations where the cloth material is folded over.

7. The method of claim 1, wherein the adhesive-backed hygiene article has wings and the first substrate has recesses to accommodate the wings of the adhesive-backed hygiene article and the cloth material to be folded over to the bottom surface of the first substrate adjacent to the recesses.

8. The method of claim 7 further comprising cutting the cloth material to reduce formation of pleats upon adhering the cloth material to the first substrate.

9. The method of claim 7 further comprising cutting the wings or repositioning the article axially.

10. The method of claim 1 further comprising replacing cloth material after a 3-20 test cycles.

11. The method of claim 1, wherein the measuring step comprises measuring the force and the slope of the force based on the linear distance traveled by the at least one weight load.

12. The method of claim 11 further comprising obtaining, from the force measured, an average force during the distance traveled corresponding to when the at least one weight is in contact with the adhesive-backed hygiene article.

13. The method of claim 1, wherein the adhesive-backed hygiene article is selected from the group consisting of a feminine care pad with or without wings, a breast pad, and an adult incontinence pad.

14. The method of claim 1, wherein the at least one weight has a linear protrusion and the second substrate has a linear groove on its bottom surface adapted to mate with the protrusion as the at least one weight moves.

15. The method of claim 1 further comprising marking an indicator point on the inner side of the adhesive-backed hygiene article at a point corresponding to the central point of contact of the at least one weight with the article.

16. The method of claim 1, wherein the cloth material is selected from the group consisting of cotton, polyester, silk, nylon, spandex, elastane, reconstituted cellulose, wool, or blends thereof.

17. The method of claim 1 further comprising, prior to the exerting force step, at least one of the following: insulting the article with fluid, exposing the article to an increased temperature for a specified duration, or applying weight to the article.

18. A system for testing an adhesive used for an adhesive-backed hygiene article, said system comprising:
a first substrate having a top surface adapted to accommodate a cloth material and an adhesive-backed hygiene article adhered to the cloth material;
a second substrate mounted to the first substrate defining a gap between the first substrate and the second substrate;
at least one weight disposed on the top surface and positioned within the gap;
a force measurement system for exerting force on the at least one weight to move the at least one weight over the cloth material and to detach the adhesive-backed hygiene article from the cloth material, while measuring the force as the at least one weight moves after the at least one weight contacts the adhesive-backed hygiene article.

19. The system of claim 18 further comprising a lead line attached to the at least one weight, wherein the second substrate has an opening to accommodate the lead line, wherein the lead line is attached to the force measurement system.

20. The system of claim 18, wherein the at least one weight consists of one weight.

21. The system of claim 18, wherein the at least one weight consists of two weights.

22. The system of claim 18 further comprising hook tape adhered to the top surface of the first substrate and the bottom surface of the first substrate at locations where the cloth material is folded over.

23. The system of claim 18, wherein the first substrate has recesses to accommodate the wings of the adhesive-backed hygiene article and the cloth material to be folded over to the bottom surface of the first substrate adjacent to the recesses.

24. The system of claim 18, wherein the at least one weight has a linear protrusion and the second substrate has a linear groove on its bottom surface adapted to mate with the protrusion as the at least one weight moves.

25. The system of claim 18, wherein the force measurement system comprises means for determining the average force as the at least one weight moves after the at least one weight contacts the adhesive-backed hygiene article and the slope of a force-distance curve as the at least one weight moves after the at least one weight contacts the adhesive-backed hygiene article.

26. An adhesive formulation having the most optimal adhesive properties relative to a plurality of adhesive formulations tested according to the method of claim 1.

27. A feminine care pad made with the adhesive formulation of claim 26.
